(19) United States
(12) Patent Application Publication
(10) Pub. No.: US 2016/0063561 A1
(43) Pub. Date: Mar. 3, 2016

(54) Method and Apparatus for Biometric Advertisement Feedback Collection and Utilization

(71) Applicant: Ford Global Technologies, LLC, Dearborn, MI (US)

(72) Inventors: Perry Robinson MacNeille, Lathrup Village, MI (US); Yimin Liu, Ann Arbor, MI (US); Oleg Yurievitch Gusikhin, West Bloomfield, MI (US)

(21) Appl. No.: 14/472,819

(22) Filed: Aug. 29, 2014

(51) Int. Cl. G06Q 30/02

(52) U.S. Cl. CPC G06Q 30/0265; G06Q 30/0269

(57) ABSTRACT

A system includes a processor configured to deliver an initial advertisement to a vehicle occupant. The processor is also configured to receive subconscious physiological feedback from one or more vehicle sensors in response to the initial advertisement being played to the occupant. Further, the processor is configured to evaluate the received feedback to determine a user response to the initial advertisement and select a next advertisement for delivery based on the results of the evaluation.

### TECHNICAL FIELD

The illustrative embodiments generally relate to a method and apparatus for biometric advertisement feedback collection and utilization.

### BACKGROUND

In recent television events, real-time advertisement analytics have been used to adjust advertisers' strategy while the program (e.g., the SUPERBOWL) is underway. The method involves placing a camera, on the TV of selected participants, which records video streams and movement of the viewers. Their posture, gaze direction, facial expression, etc. are used to determine engagement with the advertisements while the advertisements are playing, as well as to gauge the viewers' emotional reactions. If a advertisements are not producing the desired effects or increasing the awareness of products or brands, the program can be modified in real-time.

### SUMMARY

In a first illustrative embodiment, a system includes a processor configured to deliver an initial advertisement to a vehicle occupant. The processor is also configured to receive subconscious physiological feedback from one or more vehicle sensors in response to the initial advertisement being played to the occupant. Further, the processor is configured to evaluate the received feedback to determine a user response to the initial advertisement and select a next advertisement for delivery based on the results of the evaluation.

In a second illustrative embodiment, a computer-implemented method includes delivering an initial advertisement to a vehicle occupant. The method also includes receiving subconscious physiological feedback from one or more vehicle sensors in response to the initial advertisement being played to the occupant. Further, the method includes evaluating, via an analysis computer, the received feedback to determine a user response to the initial advertisement and selecting a next advertisement for delivery based on the results of the evaluation.

In a third illustrative embodiment, a non-transitory computer-readable storage medium stores instructions that, when executed by a processor, cause the processor to perform a method including delivering an initial advertisement to a vehicle occupant. The method also includes receiving subconscious physiological feedback from one or more vehicle sensors in response to the initial advertisement being played to the occupant. The method further includes evaluating the received feedback to determine a user response to the initial advertisement and selecting a next advertisement for delivery based on the results of the evaluation.

### BRIEF DESCRIPTION OF THE DRAWINGS

FIG. 1 shows an illustrative vehicle computing system;

FIG. 2 shows an illustrative example of a cascade of physiological models;

FIG. 3 shows an illustrative example of how an advertisement server can provide advertisements to a vehicle occupant;

FIG. 4 shows an illustrative example of an advertisement provision process; and

FIG. 5 shows an illustrative example of an advertisement presentation process running at a vehicle.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

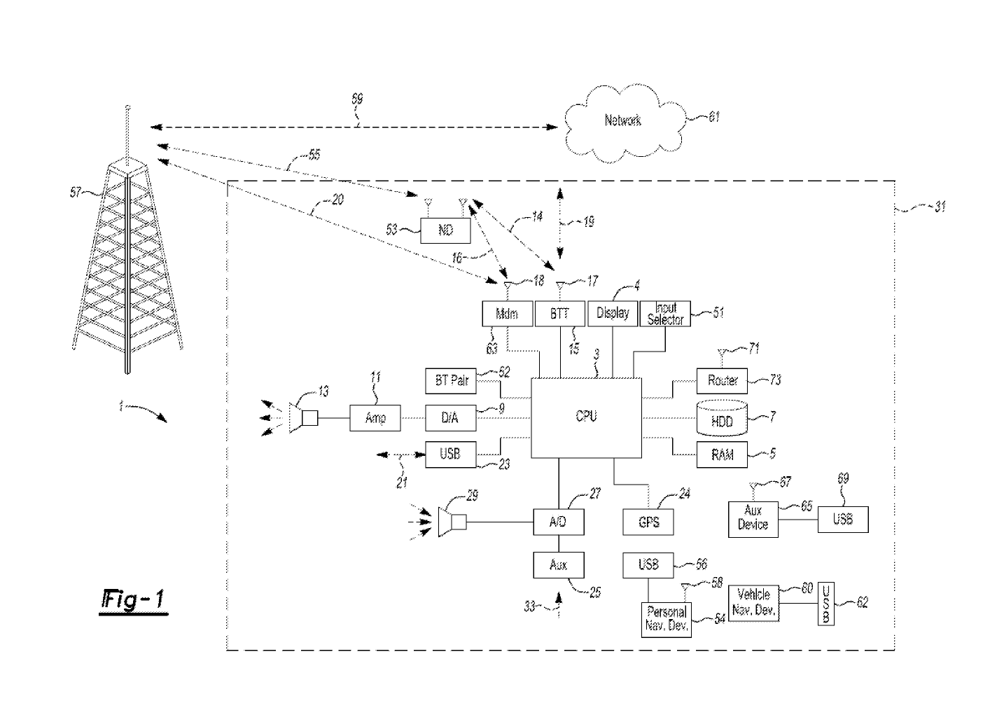

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11 g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself One of ordinary skill in the art will understand when it is inappropriate to apply a particular VACS to a given solution. In all solutions, it is contemplated that at least the vehicle computing system (VCS) located within the vehicle itself is capable of performing the exemplary processes.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

Similar to the TV biometric concept, the illustrative embodiments describe an approach that can be used in the embryonic direct digital marketing to vehicle occupants that will evolve as vehicles are connected to the internet. The types of biometric measurements that can be made in-vehicle are much more comprehensive that those that are available using a video in a living room. Further, advertisements are likely to be individualized, interactive and designed to enhance the driving experience while being required to improve driver performance and distracting the driver.

Thus, while the purpose is similar to the pioneering efforts on the SUPERBOWL advertising concept, the implementation is quite different. In-vehicle advertisement review and systems and methods of capturing subjective (non-verbal) emotional expression, which emphasizes capturing facial expression and using expression (facial) recognition system to determine the effects of advertisements is described in commonly owned and co-pending patent application Ser. No. 13/834,330, filed on Mar. 15, 2013, the contents of which are hereby incorporated by reference.

In the illustrative embodiments, implementation may be in a service oriented architecture (SOA) platform modified to be implemented on a new type of content delivery network of vehicles (vCDN). This network may incorporate vehicles in motion that are connected to the stationary infrastructure over wireless metropolitan area networks (wWAN) such as WiMax or Global System for Mobile communication (GSM) or over dedicated short-range communication (DSRC) (such as is used for automatic toll collection). These communication networks are in the early design and implementation stages.

Furthermore, the biometrics may include other indicators besides facial expressions. For example, without limitation, sensors that sense the driving seat or passenger seats may capture the “bottom print” or the weight of the person. If the person is overweight, for example, advertisements related to weight control could be sent to the vehicle computing system. Or, for example, if there are commonly children inside the vehicle (detectable by weight sensors, video sensors, etc.), then advertisements related to children's products could be considered.

In at least one embodiment, a fundamental communication unit is known as a micro-interaction. The micro-interaction is a particle of code that runs in vehicles to present the driver or other occupants with a dialog. Emotional reactions can be inferred from responses. For example, without limitation, emotion can be inferred from spoken responses, from touch display tracking, response time (Stroop effect), etc.

An example of micro-interaction utilization may be as follows. This example is provided for illustrative purposes only, and is not intended to limit the scope of the invention. In this example, a user is listening to music through an advertisement-supported music application. When an appropriate advertisement point is reached, the system initiates a dialogue with a human listener. This can include, but is not limited to, a light on the dashboard, a chime, a haptic notification, a spoken message, etc. Dialogue does not necessarily mean a language-based dialogue.

Associated with the dialogue is a grammar, usable to interpret user response(s) to the initial prompt. Once the appropriate response is received, the response can be interpreted by an analysis module. If the context of the response indicate that the dialogue should continue (e.g., more detail on an advertisement seems to be desired), the process can send a further message to vehicle occupants and again wait for a response.

Once more, if a response indicates that the dialogue should again continue, another message may be sent, and a response received. At this point, for example, a coupon or similar “deal” may be presented to the user, because feedback has shown a high degree of interest in an advertisement.

While this process describes a dialogue with responses, this is not a dialogue in the traditional sense. Through use of physiological feedback, user responses to messages can be subconscious and thus the user may not even consciously be aware of participation in a dialogue. For example, if a message about a restaurant is sent, the user may exhibit signs of hunger. If further information is provided, the user may exhibit signs of increased interest in the information, at which point a direct offer can be made to the user to secure business (if needed). Thus, the user has engaged in a “dialogue” with the advertisement server without even necessarily being aware of participation in the dialogue.

Occupant emotions can also be inferred by sensors on the vehicle typically used for other purposes. For example, without limitation, vehicle speed, lane switching rate, lateral acceleration, steering wheel reversal rate, throttle pedal reversals, brake activations and vehicle seats or seat belts can be a measure of physiological or physical states. Biometric sensors used for wellness purposes may also be used to detect the physiological response to an advertisement (or other media) presented to the driver.

Biometric sensors include, but are not limited to, weight, height, gender, age range, body temperature, heart rate, respiration rate, skin galvanometric measures, cortisol excretion, steering wheel grip strength. They can also include image analysis of data from a video camera for gender, age, race, facial expression, color, pupil dilation. Other sensors include tracking of worn objects such as jewelry, glasses, low-power lights, silhouette, etc. Also, special sensors can be added to the vehicle to specifically test for the physiological responses due to interaction with a micro-interaction. These sensors could be brain wave sensors, gaze direction contact lenses, retinal scanners, blood pressure devices, and spectral analysis devices such as blood oxygen and perfusion devices, blood sugar devices, etc. Another group of sensors include medical devices a vehicle occupant may wear or have implanted. Examples of implants include, but are not limited to, pacemakers, insulin pumps, implanted defibrillators, and other implantable devices that support telemetry between the device and the vehicle. Wearable devices such as activity trackers wearable watches and head mounted displays such as GOOGLE GLASS (gaze direction, pupil size, blood sugar, etc.) can also provide the vehicle with biometric data. Sousveillance devices, which are devices that can track user activity through use of wearable devices, can be combined with eye tracking to determine what a vehicle occupant is looking at as a micro-interaction is executed.

The sensors described are unobtrusive sensors that monitor vehicle occupants without requiring the occupant's time or attention, but may require physiologic models that provide ambiguous answers. An alternative is asking the driver for a self-assessment which demands the driver's time and attentions, and this also may still give ambiguous or deceptive results and require compensation for the answering occupant's time.

Physiological models can also be developed as particles of code to run, for example, without limitation, on a vehicle, cell-tower, in parallel on repetition servers, in an origin server or on supercomputers used by analysts for data mining. A cascade of physiological models reduces raw sensor data into physiological and emotional responses. Because the vehicle is part of a CDN, it is possible to process the sensor data at various levels.

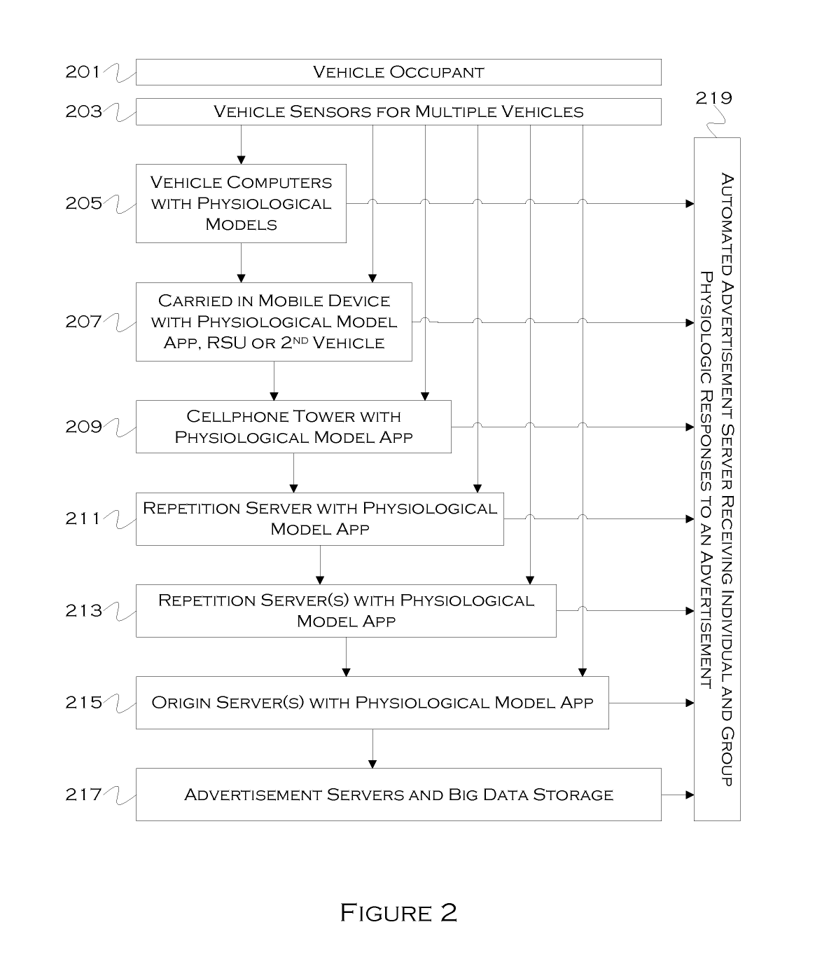

FIG. 2 shows an illustrative example of a cascade of physiological models. In this illustrative example, raw data originates with the vehicle occupants 201. The raw data may be detected by vehicle sensors 203 and processed by vehicle computers 205. The processed data and sensor data moves through the CDN to the next level 207, where it is processed again and another physiological model processes the previous results along with the vehicle sensor data. At this level 209 (the cell phone tower) the physiological model may also aggregate data and results from the previous level from multiple vehicles. This allows processing of a population of occupants rather than only one.

Repetition servers 211, 213 can further process the data from the cell phone tower, as well as data directly from the vehicle sensors. The data may also then be passed to an origin server 215, which may be running a physiological model application. Finally, in this example, the data may be passed to advertisement servers and/or big data storage 217. From any physiological model/processing point, the data may further be passed to an advertisement server 219. This server can receive individual and/or group physiological responses to a presented advertisement. While a fairly detailed tiered model is shown for illustrative purposes, not all levels are required in every implementation.

Sensor devices provided to the vehicle for analysis purposes can have associated opt-in/opt-out switch(es) that allows physiological monitoring to be turned off. Data may also be encrypted and anonymized to protect privacy.

An exemplary implementation of the top layer origin servers follows from Engineering@Facebook (https://code.facebook.com/) and could be implemented in an information technology department of a vehicle manufacturer. Second layer repetition servers can be implemented, for example, using Apache Foundation (http://trafficserver.apache.org/). The three middle layers offer a number of optional paths for data to flow that are very different from traditional desktop-based and mobile-based content delivery networks:

For example, the vehicle may connect directly to a stationary cell tower that is federated into one of the traditional CDNs. Typically this would happen when a telematics control unit or an Accessory Protocol Interface Module have a Global System for Mobile communications (GSM) modem that allows connection between vehicle components and cell towers.

Additionally or alternatively, the vehicle may connect to roadside units using the IEEE 1609, 802.11 protocols. The roadside units (RSU) may connect to the internet via Internet Protocols or with cell towers via GSM protocols. A vehicle may connect to the internet using IEEE 1609, 802.11 protocols via another vehicle that uses either RSU or cell towers to connect wirelessly to the internet. Ideal content delivery networks will support opportunistic network connection because the availability of any of the possible connections may be limited. Of course, if it is impractical to provide these due to, for example, complexity or expense, such opportunistic connection is not necessary.

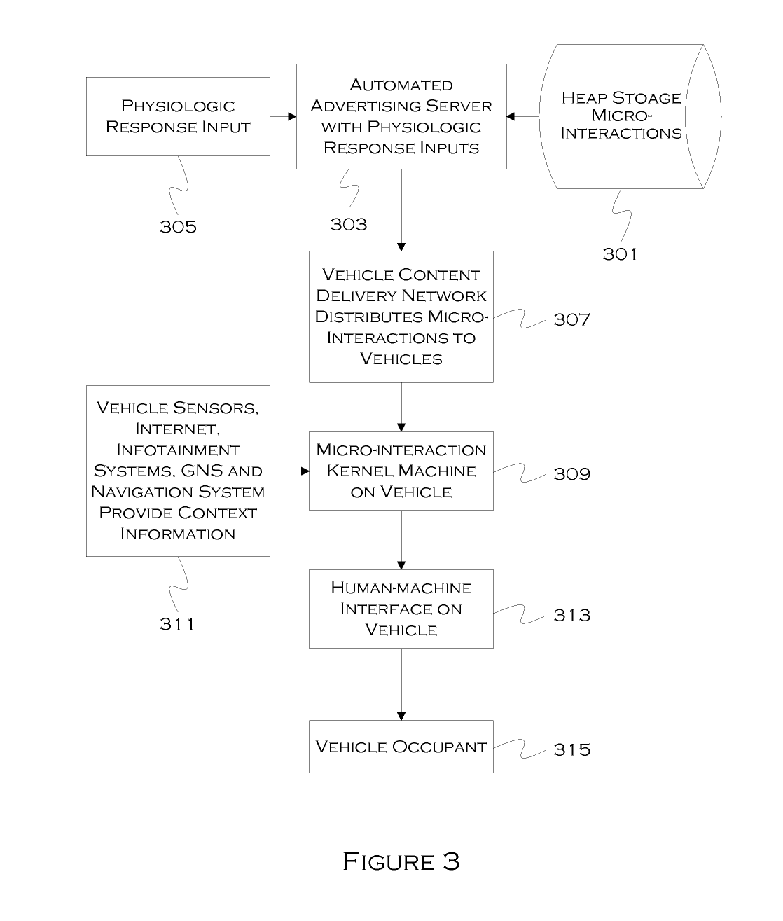

FIG. 3 shows an illustrative example of how an advertisement server can provide advertisements to a vehicle occupant. In this illustrative example, a database 301 stores a variety of observed micro-interactions that may be produced by a vehicle occupant in response to an advertisement presentation. These interactions, as well as physiologic response inputs 305, produced by the vehicle occupant(s), can be fed into an automated advertising server 303.

The advertising server utilizes a vehicle content delivery network 307 to distribute the micro-interactions to vehicles connected to the server. These advertisements can be provided, for example, as part of advertising supported content, or could, in some cases, even be utilized by radio stations for provision in advertising slots. Appropriate revenue sharing models can be utilized if the automotive manufacturer is provided the advertisements and analysis.

Next, in this system, vehicle sensors, the Internet, the infotainment system and a navigation system 311 may provide context information for use by a micro-interaction kernel machine running on a vehicle 309. Other suitable inputs may also be utilized as appropriate. This kernel interacts with a human-machine interface (HMI) 313 on the vehicle, which can be utilized to present the advertisement(s) to the vehicle occupant 315. Physiological responses from the vehicle occupant can be tracked and fed back into the automated advertising server 303, to repeat the process until advertising provision is no longer needed for an advertisement segment.

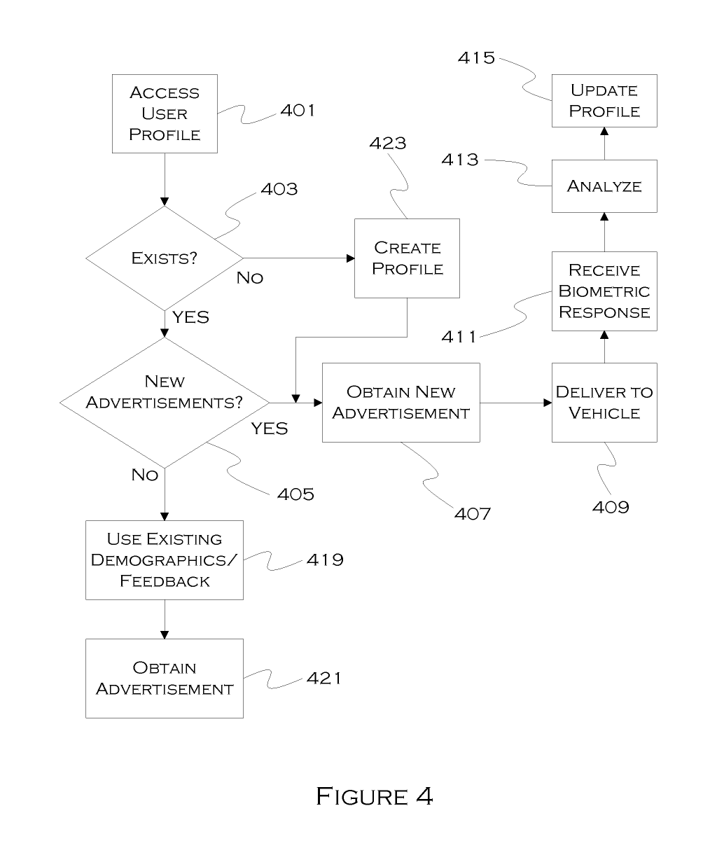

FIG. 4 shows an illustrative example of an advertisement provision process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

When a vehicle is started, or, for example, when it is nearing time to present an advertisement, the process can access a user-profile 401. The user profile can be utilized to track specific user physiological feedback. With time, it can be determined which responses from a user equate to positive or negative feedback to an advertisement.

For example, without limitation, a user may experience an elevated heart rate when an advertisement is enjoyed or appreciated. On the other hand, a different user may experience an elevated heart rate when an advertisement is not appreciated. Since the vehicle may not initially know which reaction equates to which result, other behavior may be observed in conjunction with the elevated heart rate. Decisions can be based on, for example, aggregated common responses equating to likes or dislikes.

For example, if the user's heart rate elevates, and six other signs are detected that generally tend to correlate to enjoyed advertisements, the system may equate an elevated heart rate with a positive advertisement. Refinement of a specific user's responses may be made over time, and stored with respect to a user profile so that feedback can be more accurately interpreted and advertisements can thus be better tailored for a given user.

If the user profile does not exist, the process will create a user profile 423 and, in this example, select an advertisement of a certain type 407. This may be randomly selected, or, for example, may be selected based on context information obtainable even without the aid of any user profile information (e.g., without limitation, weight, age, socio-economic status (determinable by vehicle price, for example), etc.).

Similarly, if the user profile does exist 403, and the user has negatively responded to one or more advertisements of a given type, for example, the process may determine that a new advertisement category is needed 405. A new category may also be needed if the system does not wish to play consecutive advertisements relating to the same class of goods or services.

On the other hand, if a user physiological response indicates that a new advertisement set is not yet needed 405, the process may update the user profile to indicate interest in the particular playing advertisement set 419 and obtain another advertisement 421 in accordance with the demonstrated preference exhibited by positive physiological feedback.

Next, whether in the same category/set or in a new category/set, the advertisement is delivered to the vehicle 409. Advertisement categories and sets can include advertisements for a certain good or service, or can be more broadly categorized in classes of goods and services. For example, if a user responds positively to “outdoorsy” advertisements, an advertisement for a gun store can be followed by an advertisement for a hunting getaway, which can be followed by an advertisement for a sportsman magazine. If the user interest begins to wane (as expressed by the physiological feedback), a new category can be selected. New category selection can be based on, for example, without limitation, known preferred categories, random categories, similar categories to preferred categories, vehicle context information, etc.

After the advertisement is delivered to the vehicle (and played to an occupant), physiological, biometric feedback may be received 411. This feedback can be passed to the appropriate location(s) for analysis 415 and, based on the feedback, a user profile can be updated 417 to reflect both user advertisement preferences and to refine understanding of user physiological responses. The feedback can also be fed back into the advertisement selection process to determine if a new advertisement set is needed or not 405.

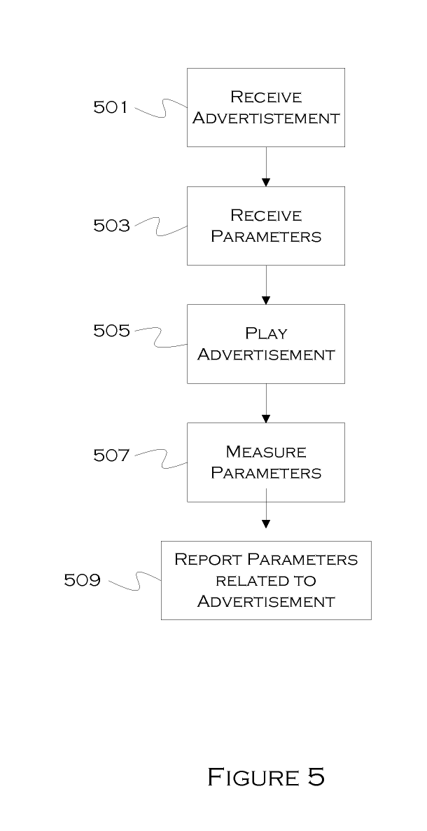

FIG. 5 shows an illustrative example of an advertisement presentation process running at a vehicle. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, a fairly simple process is shown for illustrative purposes only. An advertisement is received from an advertisement provision source 501. In conjunction with the advertisement, in this example, a set of parameters to be measured by the vehicle sensors is also received 503. The parameters may be defined by the advertisement provider, as in this example, or, in other instances, the vehicle may simply gather as much data as sensors will allow, or in accordance with a standardized gathering profile.

Once received, the advertisement is played-back for one or more vehicle occupants 505. Presumably, whether consciously or not, the vehicle occupant(s) will respond in some manner to the advertisement. These responses can be measured 507, and, to the extent that a vehicle can differentiate between users, specific user profiles can be updated. This is useful to refine the profiles for multiple users simultaneously (to improve individual experiences for each user). Also, the advertisement server may use multiple user profiles to select advertisements preferred by the majority of users in the vehicle. Or, for example, if children are present, alcohol advertisements, for example, may be prohibited.

In this example, the measured responses are then reported back to a processing server. In this example, while a multitude of parameters may be measured, the system may only report back the requested parameters 509. Or, for example, the system may only measure and report the requested parameters. In other examples, all parameters may be reported, or non-requested parameters may be measured and used for other purposes.

The illustrative embodiments provide systems and methods of utilizing physiological feedback in response to advertisements that can operate on a “service oriented architecture” (SOA) on a vehicle content delivery network (vCDN). By using these subconscious responses, the illustrative embodiments can improve driver performance, reduce driver distraction, improve the driving experience and detect what advertisements vehicle occupants prefer in real time.

Through use of the physiological responses, the illustrative embodiments provide sophisticated feedback to advertisers that allow them to update advertising strategies in real-time and increase brand awareness. The illustrative embodiments further support individualized automated advertising strategies that operate in real-time. By utilizing many existing vehicle sensors besides in-vehicle video, the system integrates a number of sensors that are quite possibly to be mandated in the future, as the sensors frequently provide increased awareness of potential emergency situations (driver medical conditions, driver distraction, driver drowsiness, etc.).

Additionally, the illustrative embodiments may utilize vehicle sensors that can be used specifically for supporting automated advertisements. Tailor made sensors can be designed to measure optimal response types that are likely to provide the most accurate feedback data. The data may be using “big data” methods that allow for analysis of both individuals and entire populations. This can provide numerous revenue streams for automotive original equipment manufacturers, after a vehicle has already been sold.

From a safety and desirability perspective, the illustrative embodiments (and similar embodiments) are unobtrusive, in that they do not require the driver or other occupant to do a self-assessment. Self-assessments are considered by some to be the most accurate way of determining physiological state and in particular the likelihood that the advertisement will lead to a desired change in behavior. However, the indirect approaches described here do not require the occupant's time, energy and conscious attention (although the driver can be directly engaged in the dialogue if desired).

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
deliver an initial advertisement to a vehicle occupant;
receive subconscious physiological feedback from one or more vehicle sensors in response to the initial advertisement being played to the occupant;
evaluate the received feedback to determine a user response to the initial advertisement; and
select a next advertisement for delivery based on results of the evaluation.

2. The system of claim 1, wherein the next advertisement is a more detailed advertisement relating to the initial advertisement, selected based on positive physiological feedback.

3. The system of claim 1, wherein the processor is configured to store the results of the evaluation in an analysis-related database.

4. The system of claim 1, wherein the processor is further configured to update a user profile based on the results of the evaluation.

5. The system of claim 4, wherein the update includes updating a positive or negative preference for a product or service advertised in the initial advertisement based on the results of the evaluation.

6. The system of claim 4, wherein the update includes updating a positive or negative preference for products or services related to a product or service advertised in the initial advertisement based on the results of the evaluation.

7. The system of claim 4, wherein the update includes updating a physiological response's correlation to positive or negative preference based on the results of the evaluation.

8. The system of claim 1, wherein the processor is configured to select a next advertisement for a category related to the initial advertisement, and to continue to successively select similar next advertisements until the results of the evaluation fall below a negative response threshold level.

9. A computer-implemented method comprising:
delivering an initial advertisement to a vehicle occupant;
receiving subconscious physiological feedback from one or more vehicle sensors in response to the initial advertisement being played to the occupant;
evaluating, via an analysis computer, the received feedback to determine a user response to the initial advertisement; and
selecting a next advertisement for delivery based on results of the evaluation.

10. The method of claim 9, wherein the next advertisement is a more detailed advertisement relating to the initial advertisement, selected based on positive physiological feedback.

11. The method of claim 9, further comprising storing the results of the evaluation in an analysis-related database.

12. The method of claim 9, further comprising updating a user profile based on the results of the evaluation.

13. The method of claim 12, wherein the update includes updating a positive or negative preference for a product or service advertised in the initial advertisement based on the results of the evaluation.

14. The method of claim 12, wherein the update includes updating a positive or negative preference for products or services related to a product or service advertised in the initial advertisement based on the results of the evaluation.

15. The method of claim 12, wherein the update includes updating a physiological response's correlation to positive or negative preference based on the results of the evaluation.

16. The method of claim 9, further comprising selecting a next advertisement for a category related to the initial advertisement, and continuing to successively select similar next advertisements until the results of the evaluation fall below a negative response threshold level.

17. A non-transitory computer-readable storage medium storing instructions that, when executed by a processor, cause the processor to perform a method comprising:
delivering an initial advertisement to a vehicle occupant;
receiving subconscious physiological feedback from one or more vehicle sensors in response to the initial advertisement being played to the occupant;
evaluating the received feedback to determine a user response to the initial advertisement; and
selecting a next advertisement for delivery based on results of the evaluation.

18. The storage medium of claim 17, further comprising updating a user profile with a positive or negative preference for a product or service advertised in the initial advertisement based on the results of the evaluation.

19. The storage medium of claim 17, further comprising updating a user profile with a positive or negative preference for products or services related to a product or service advertised in the initial advertisement based on the results of the evaluation.

20. The storage medium of claim 17, further comprising updating a user profile with a physiological response's correlation to positive or negative preference based on the results of the evaluation.
